(19) United States
(12) Patent Application Publication
(10) Pub. No.: US 2005/0245238 A1
(43) Pub. Date: Nov. 3, 2005

(54) Method of function execution to reduce the memory usage in a wireless system

(76) Inventor: Nai-Sheng Cheng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/833,138

(22) Filed: Apr. 28, 2004

(51) Int. Cl. G06K 9/00; H04Q 7/20

(52) U.S. Cl. 455/412.1; 455/514

(57) ABSTRACT

A method of function execution to reduce memory usage in a wireless system. An image is processed in blocks rather than a complete image. Multiple functions are executed for the same block. When all the functions have been executed for a particular block, the next block is processed. This is repeated until all functions have been executed for all blocks. Programming is achieved by first programming parameters for each function. Then each function is defined in a recursive command after which the recursive command is fired for execution and all functions are automatically executed. The system comprises a base band with an application processor, a media processor with a command manager and function units, and an LCD module with a panel and a frame buffer. The method significantly reduces the amount of memory required which not only lowers cost but also greatly simplifies the system.

### BACKGROUND OF THE INVENTION

1. Field of the Invention

The present invention relates to a method of executing functions. More specifically, the present invention discloses a method of executing functions that reduces the memory usage in a wireless system.

2. Description of the Prior Art

Video conferencing is rapidly increasing in popularity as a form of audio visual communication when more than one or more of the communicators are unable to be in the same location.

As useful as video conferencing is however, its power is limited by the resources available to the telecommunication equipment. Since a large quantity of data is required to provide the audio and video information to the opposite party, any bottlenecks or inefficiency in the communication system will greatly hinder the performance of the audio and video stream. As a result, poor quality or disjointed video or audio with dropouts will be present.

In a microprocessor-based system, different commands are executed in order to perform specific functions. After one function has been completed, another command or set of commands is executed to perform another function. The steps of this conventional method are 1) the parameter or parameters for the first function are programmed, 2) the first function is executed, 3) the parameters or parameters for the second function are programmed, 4) the second function is executed, etc.

Alternatively, the steps are 1) the parameter or parameters for the first function are programmed, 2) the parameter or parameters for the second function are programmed, etc. . . . until all parameters for all functions have been programmed, 3) the first function is executed, 4) the second function is executed, etc.

This method of processing requires a huge working memory space in order to execute and process the instructions and parameters for all the functions.

While this may be acceptable for some applications, when used with large data applications such as video conferencing, the inefficiency of this method quickly becomes apparent and the system performance is less than optimal. In addition, systems utilizing this method have higher system requires such as a large amount of memory, thus unnecessarily driving up the cost of the system.

Therefore, there is need for an improved method of function execution to reduce the memory usage in a wireless system and as a result improves the performance and expands the capabilities of the wireless system.

### SUMMARY OF THE INVENTION

To achieve these and other advantages and in order to overcome the disadvantages of the conventional method in accordance with the purpose of the invention as embodied and broadly described herein, the present invention provides a method of executing functions that reduces the memory usage in a wireless system.

As described above, the conventional methods for executing functions are not adequate. In addition, if a conventional method were to be applied to video conferencing via a handset or mobile telephone, the result would be very poor. The quality of the results would be further be lowered if it was desired to not only view a video image and hear the audio of the receiving party as well as view a video image and hear the audio of the caller. Therefore, a new method must be utilized to cope with these types of increased demands and services.

Taking the above dual video conferencing as an example, instead of processing the complete display or even one half of the display which could be the video of either the caller of the receiver, the method of the present invention breaks the display into smaller blocks. Once the display is segmented, multiple functions are executed for the same block. When all the functions have been executed for a particular block, the next block is processed. This is repeated until all functions have been executed for all blocks.

Programming is achieved by first programming parameters for each function. Then each function is defined in the recursive command. After all functions have been defined, the recursive command is fired for execution and all functions are automatically executed.

Functions can be, but not limited to, adding text to the image, overlaying the date over the image, color correction, etc.

A system that utilizes the method of the present invention typically comprise a base band with an application processor, a media processor with a command manager and function units, and an LCD module with an LCD panel and a frame buffer. The command manager can be located in the base band, media processor, or LCD module. Also, the command manager can be realized in software, hardware, firmware, or a combination of these.

Utilizing the present invention a significant reduction in the amount of memory required for the system or device is achieved. This not only lowers cost but also greatly simplifies the system.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart illustrating a method of function execution according to an embodiment of the present invention;

FIG. 2 is a flowchart illustrating a method of function execution according to an embodiment of the present invention;

FIG. 3 is a diagram illustrating a programming method according to an embodiment of the present invention;

FIG. 4 is a drawing illustrating memory and recursive buffers;

FIG. 5 is a chart illustrating the contents of the recursive buffers versus time; and

FIGS. 6A-6C are block diagrams of a system utilizing the method of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

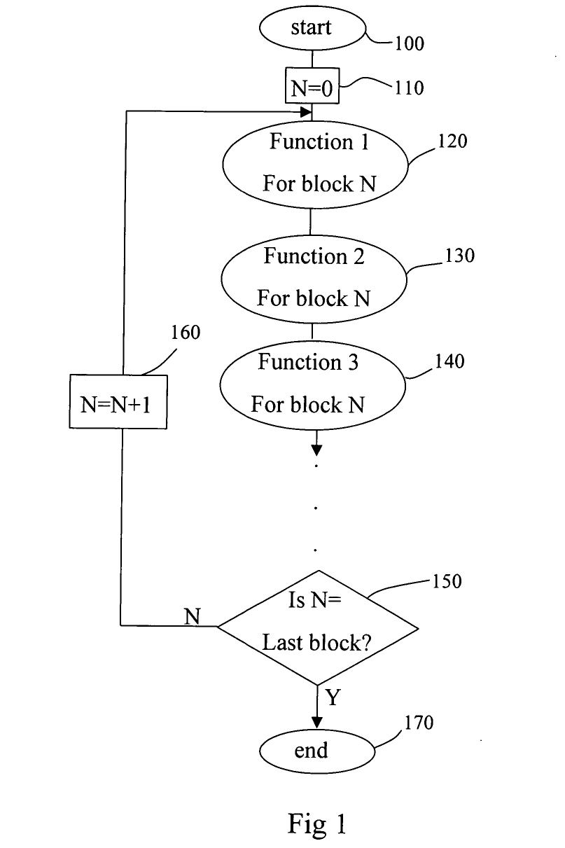

Refer to FIG. 1, which is a flowchart illustrating a method of function execution according to an embodiment of the present invention.

As shown in FIG. 1, after starting in step 100, a counter, for example n, is set to zero in step 110. In step 120, the first function or function 1 is executed for block n. Subsequentially, in step 120, function 2 is executed for block n and in step 130, function 3 is executed for block n. This is continued until all functions have been executed for block n. In step 150, it is determined whether n is equal to the last block.

For example, if block 1 was designated as the first block in the upper right hand corner of the display, the last block may be the last block in the lower right hand corner of the display. However, this is only an example. The designations for the numbering, ordering, positioning, size, or orientation of the blocks can be selected as required.

If in step 150, it is determined that block n is not the last block, then in step 160 n is incremented so that n equals n+1 and loops back to step 120. This is repeated until in step 150, n is determined to be the last block at which the routine ends in step 170.

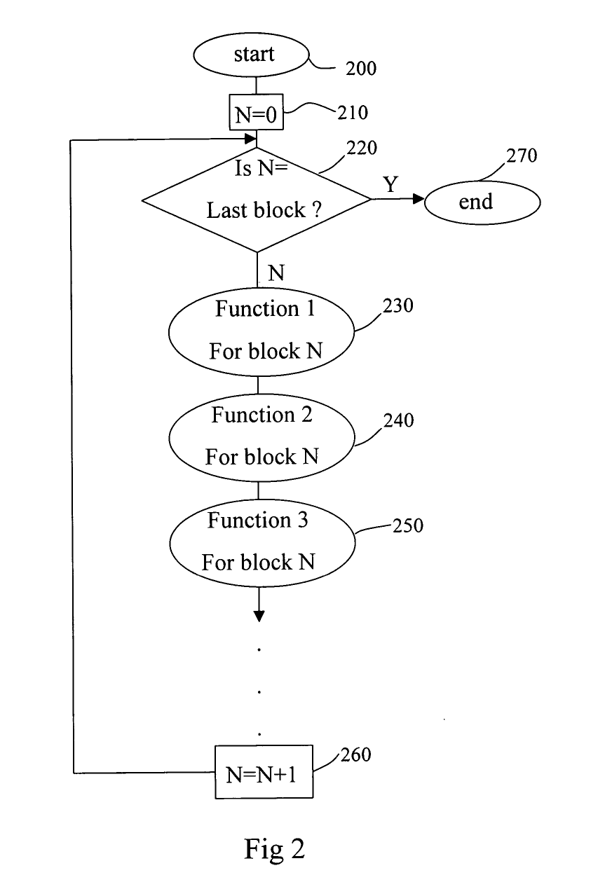

Refer to FIG. 2, which is a flowchart illustrating a method of function execution according to an embodiment of the present invention.

The flowchart shown in FIG. 2 is similar to the flowchart of FIG. 1, but with the step of determining whether block n is the final block before the function execution steps.

After starting in step 200, n is set to zero in step 210. In step 220 determination is made whether n is equal to the last block. If n is not equal to the last block, function 1 for block n is executed in step 230. Then in step 240 function 2 for block n is executed, followed by execution of function 3 for block n in step 250. This continues until all functions have been executed for block n. In step 260 n is incremented so that n equals n+1 and the routine loops back to step 220. The routine loops through the above mentioned steps until n is determined to be the last block at which time the routine ends in step 270.

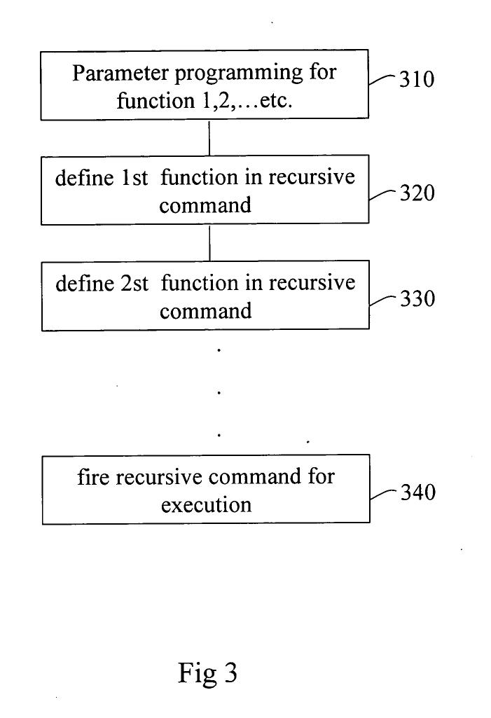

Refer to FIG. 3 which is a diagram illustrating a programming method according to an embodiment of the present invention.

The programming method begins by programming the parameters for the plurality of functions in step 310. Then the first function in the recursive command is defined in step 320. Step 320 is followed by defining the second function in the recursive command in step 330. This is continued by defining each function in the recursive command. Finally, in step 340, the recursive command is fired for execution. With the recursive command, all functions will be executed automatically.

An important feature of the method of the present invention is the utilization of a recursive buffer and a recursive command for execution. The recursive buffer is used to store blocks of image data and the recursive command is utilized to execute all functions for a block. It should be noted that the number of recursive buffers does not have to equal the number of functions. Also, since the recursive command utilizes the same working buffers in the recursive memory, a significant savings in the amount of memory is achieved.

As an example of the data stored in the recursive buffer, the follow is given. Other data, types of data, or configurations can be used as required.

Image sensor input is stored in a portion of the recursive buffer, for example the left half of the recursive buffer. This is a block of image data from the handset's built-in camera, decoder data from a decoded image block from the remote handset is stored in another portion of the recursive buffer, for example the right half of the recursive buffer.

In addition a graphic engine combines the image from the recursive buffer and copies it to the frame buffer of the display or LCD panel. A encoder encodes an image block from the image data in the recursive buffer, in this example the left half of the recursive buffer. A display interface outputs the image from the frame buffer to the LCD display.

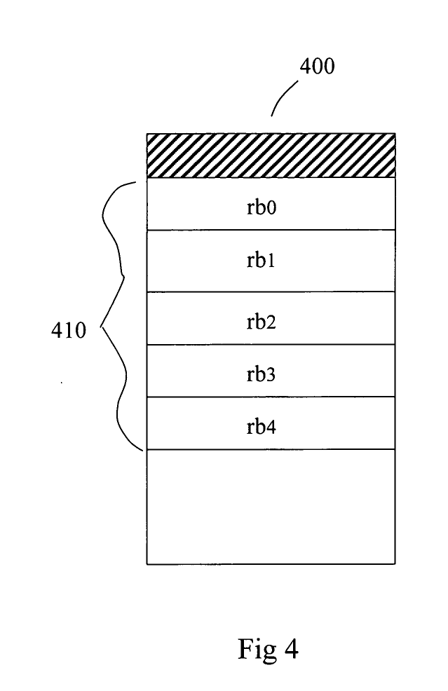

Refer to FIG. 4, which is a drawing illustrating memory and recursive buffers. The memory 400 comprises a plurality of recursive buffers 410. In this example, recursive buffers 0-4 are shown, but other numbers of recursive buffers can be used.

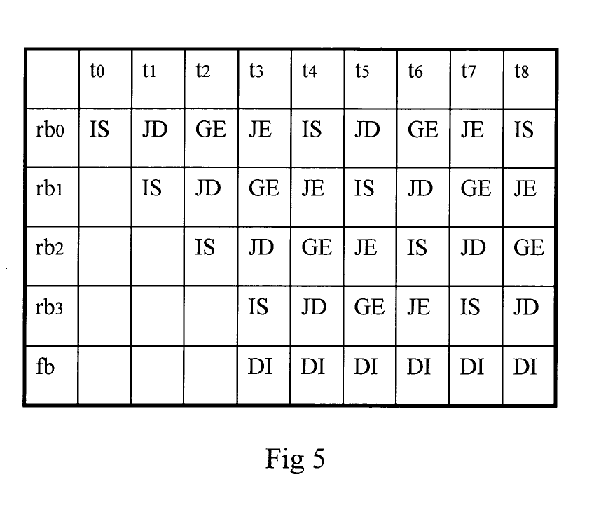

Refer to FIG. 5, which is a chart illustrating the contents of the recursive buffers versus time.

At time 0 or to recursive buffer 0 or rb0 contains a block of image from the image sensor. At t1, the image block is moved to rb1 and the decoded compressed image block from the remote handset is input into rb0. At t2, the image block and decoded compressed block are shifted to rb2 and rb1 respectively and the combined image is in rb0. At t3, the three previous are shifted to rb3, rb2, and rb1 and the encoded image is input to rb0 at which time the display interface outputs the image from the frame buffer to the LCD display.

Since the method of the present invention operates on blocks of image data rather than the complete image, a dramatic reduction in memory size is achieved. For example, for a 320×240 pixel image, the recursive buffer would require 320×240 for the image data and 320×240 for the decoder image data for a total of 153,600 pixels. However, utilizing the method of the present invention, for a block size of 8×8 pixels and 4 recursive buffers, a total of 256 pixels is needed. This means that the method of the present invention requires only 0.17% as much memory compared with processing the entire image data.

If the image data is 640×480, the image data is 614,400 pixels. Utilizing the present invention the recursive buffer only needs to hold 256 pixels. This is 4.2/10,000 as much memory required for the present invention.

If the image data is 1280×1024, the image data is 2,621,440 pixels. Utilizing the present invention the recursive buffer only needs to hold 256 pixels. This is 9.8/100,000 as much memory required for the present invention.

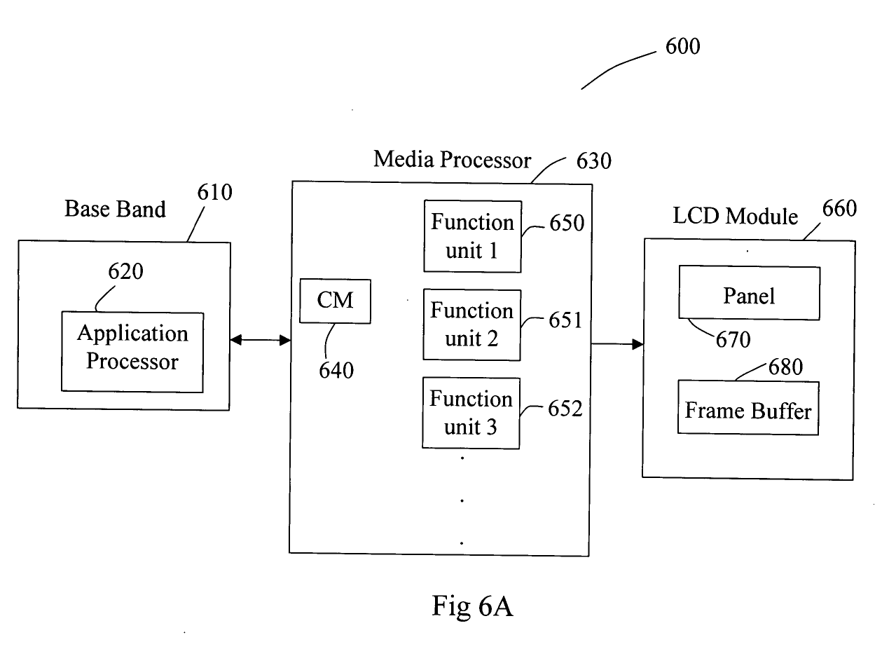

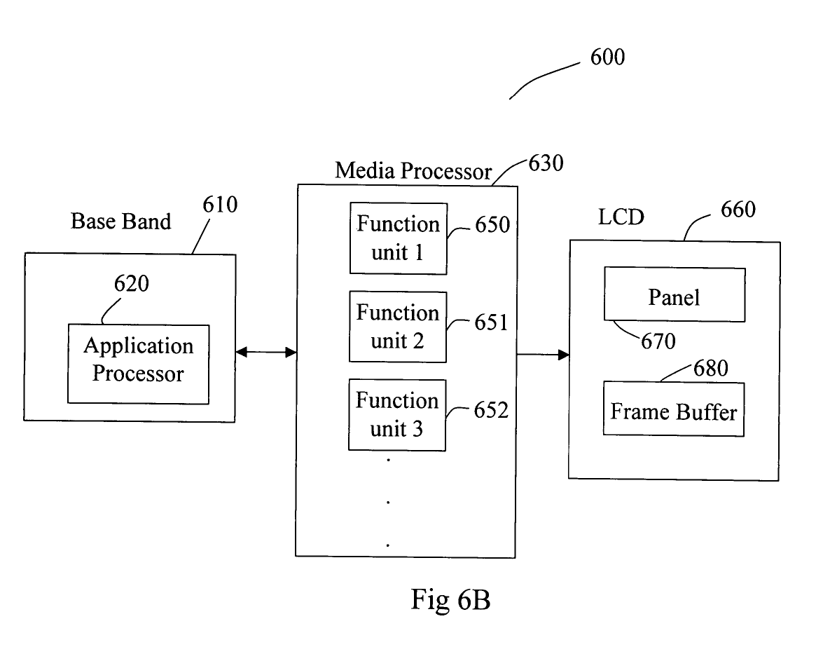

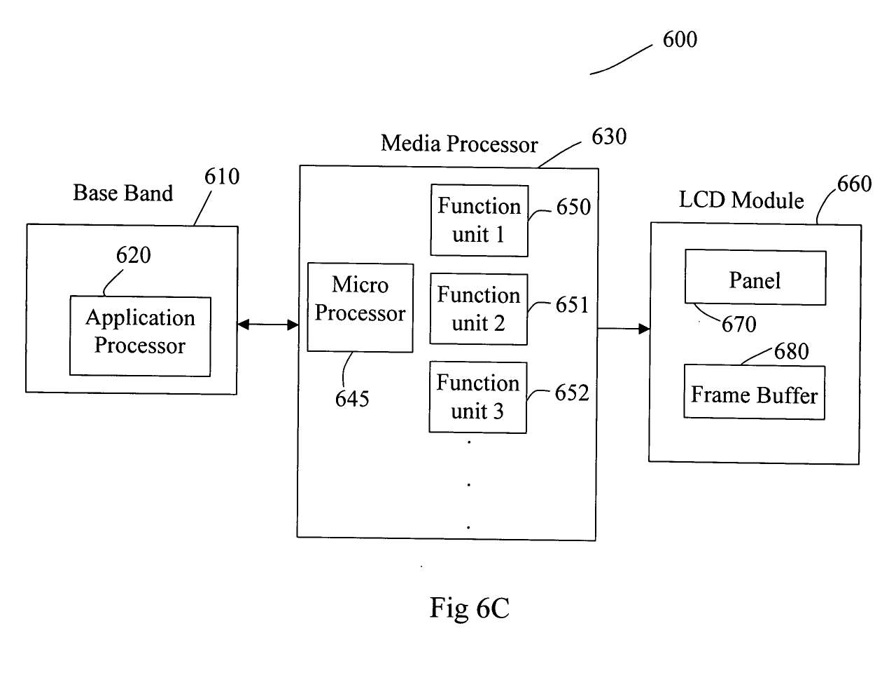

Refer to FIG. 6A, which is a block diagram of a system utilizing the method of the present invention.

The system 600 comprises a base band 610, a media processor 630, and an LCD module 660. The base band further comprises and application processor 620. The media processor comprises a command manager 640, and a plurality of function units 650, 651, 652. The command manager 640 manages the execution of the functions on the image data and follows the function unit's status. The LCD module 660 comprises a panel 670 and a frame buffer 680. The panel 670 is for displaying the image data and the frame buffer 680 is a storage buffer for the image data that the panel 670 displays.

Refer to FIG. 6B, which is a block diagram of a system utilizing the method of the present invention.

An alternative system is illustrated in FIG. 6B. This system is similar to the system shown in FIG. 6A, but the command management is handled by a software driver of the application processor 620.

Refer to FIG. 6C, which is a block diagram of a system utilizing the method of the present invention.

Another system is illustrated in FIG. 6C. In this system, the command management is handles by a microprocessor 645 in the media processor 630.

It should be understood that these are only a few examples of a system utilizing the method of the present invention. Other configurations are available. For example the media processor can be included in the LCD module or a plurality of media processors could be used. In addition, the media processor can be realized by hardware, circuitry, software, firmware, or a combination of these. Furthermore, the application processor and the media processor can be included in the LCD module. Also, multiple media processors can be implemented and functions can be processed in parallel.

Additionally the execution function is independent and can be realized in hardware or software or a combination of hardware and software.

As described above, the method of the present invention provides a dramatic decrease in memory requirements, thereby lowering cost of the device. At the same time, speed is not adversely affected. Also, the screen or image size does not affect the memory requirements as the image data is processed in blocks. Furthermore, the blocks are not limited to an 8×8 pixel block. Block size can be selected according to needs or requirements.

It should be noted that the above video conferencing application is only one application for the method. Other applications, such as image correction or image handling are well suited for application of the method. Additionally, a wireless system was given as example due to the tight memory constraints in wireless communications and communication systems. However, the present invention can be easily applied to other systems.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A method of function execution to reduce memory usage in a wireless system comprising:
splitting an image into a plurality of blocks;
executing at least one function on a first block of the plurality of blocks; and
repeating execution of the functions on every block until reaching a last block of the plurality of blocks.

2. The method of function execution of claim 1, further comprising:
programming parameters for each of the at least one function;
defining each of the at least one function in a recursive command; and
firing the recursive command for execution.

3. The method of function execution of claim 1, wherein the image is an image from an image sensor.

4. The method of function execution of claim 1, wherein the image is a decoded compressed image.

5. The method of function execution of claim 1 further comprising:
inputting a block of image data into a portion of a recursive buffer;
decoding a block of compressed image data;
inputting the block of compressed image data into another portion of the recursive buffer;
combining the blocks of image data;
copying the combined image to a frame buffer;
encoding the block of image data; and
displaying the combined image in the frame buffer on a display.

6. The method of function execution of claim 2, wherein the functions are executed in parallel.

7. The method of function execution of claim 2, wherein execution of the functions is controlled by a command manager.

8. A method of function execution comprising:
splitting an image into a plurality of blocks;
programming parameters for each of at least one function;
defining each of the at least one function in a recursive command;
firing the recursive command for execution;
executing the at least one function on a first block of the plurality of blocks; and
repeating execution of the functions on every block until reaching a last block of the plurality of blocks.

9. The method of function execution of claim 8 further comprising:
inputting a block of image data into a portion of a recursive buffer;
decoding a block of compressed image data;
inputting the block of compressed image data into another portion of the recursive buffer;
combining the blocks of image data;
copying the combined image to a frame buffer;
encoding the block of image data; and
displaying the combined image in the frame buffer on a display.

10. The method of function execution of claim 8, wherein the image is an image from an image sensor.

11. The method of function execution of claim 8, wherein the image is a decoded compressed image.

12. The method of function execution of claim 8, wherein the functions are executed in parallel.

13. The method of function execution of claim 8, wherein execution of the functions is controlled by a command manager.

14. A method of function execution to reduce memory usage in a wireless system comprising:
inputting a block of image data into a portion of a recursive buffer;
decoding a block of received image data;
inputting the block of received image data into another portion of the recursive buffer;
executing at least one function on the blocks of image data; and
repeating the inputting and decoding of image data for other blocks until a last block of image data has been processed.

15. The method of function execution to reduce memory usage in a wireless system of claim 14 further comprising:
copying the blocks of image data to a frame buffer; and
displaying the image data on a display.

16. The method of function execution to reduce memory usage in a wireless system of claim 14, further comprising:
programming parameters for each of the at least one function;
defining each of the at least one function in a recursive command; and
firing the recursive command for execution.

17. The method of function execution to reduce memory usage in a wireless system of claim 14, wherein the image is an image from an image sensor.

18. The method of function execution to reduce memory usage in a wireless system of claim 14, wherein the image is a decoded compressed image.

19. The method of function execution to reduce memory usage in a wireless system of claim 14, wherein the functions are executed in parallel.

20. The method of function execution to reduce memory usage in a wireless system of claim 14, wherein execution of the functions is controlled by a command manager.
